(19) United States
(12) Patent Application Publication
(10) Pub. No.: US 2015/0356661 A1
(43) Pub. Date: Dec. 10, 2015

(54) COSMETIC MATCHING AND RECOMMENDATIONS

(71) Applicant: Jillianne Rousay, Salt Lake City, UT (US)

(72) Inventor: Jillianne Rousay, Salt Lake City, UT (US)

(21) Appl. No.: 14/733,411

(22) Filed: Jun. 8, 2015

Related U.S. Application Data
(60) Provisional application No. 62/009,669, filed on Jun. 9, 2014.

(51) Int. Cl. G06Q 30/06; G06K 9/00; G06T 7/40; A45D 44/00

(52) U.S. Cl. CPC G06Q 30/0631; A45D 44/005; G06K 9/00268; G06T 7/408; G06T 2207/10008; G06T 2207/10024

(57) ABSTRACT

Using use hardware sensors and computer analysis on data captured by the hardware sensors to provide personalized, consistent, and objective cosmetic recommendations to a user. Embodiments include using a hardware sensing device to capture a scan a of user's face, and identifying attributes of the user's face from the scan, to provide one or more cosmetic recommendations. In such embodiments, the recommendations may be based on performing an analysis to determine a skin tone of the user's face and/or a bone structure of the user's face from the scan. Embodiments also include using a hardware sensing device to capture a scan of a subject cosmetic product, and identifying attributes of the subject cosmetic produce from the scan, to provide one or more cosmetic recommendations.

### CROSS-REFERENCE TO RELATED APPLICATIONS

This application claims priority to and the benefit of U.S. Provisional App. No. 62/009,669, filed Jun. 9, 2014, and titled “AUTOMATED COSMETIC MATCHING AND RECOMMENDATIONS,” the entire contents of which are incorporated by reference herein in their entirety.

### BACKGROUND

Selection of cosmetic products for use by an individual can be a daunting task. In general, most individuals desire to find cosmetic products that can be used to create a desired look, that work well together, and/or that work well on that individual's skin. Selection of cosmetic products is largely a trial-and-error process. As such, it often takes years for an individual to find the right mix of cosmetic products that work well to together, that work with her skin type, and that produce a desired look. This selection process is complicated by the fact that cosmetic companies continuously modify their product lines—so consumers are often faced with having to select replacement products as their existing product is discontinued. In addition, while cosmetologists can help in the selection process, varying levels of experience and the inherent subjectivity of human perception and opinion often leads to inconsistent results.

In recent years, technical computer-based tools have been developed in an attempt to aid individuals in their search for cosmetic products. For example, many cosmetic companies now make their catalogues available in computerized databases, enabling a user to have access to a great body of information. In addition, some “virtual makeover” software tools have been developed that enable users to manually select from cosmetic products, and have those product be “virtually” applied to a photo of the user.

In spite of their technical advancements, existing computer-based tools do little to address the subjective and trial-and-error nature of cosmetic selections. In fact, by inundating a user to too much information, these tools can often introduce confusion and increase the time it takes to identify cosmetic products for an individual. As such, there remains a need for further improvement to the technical field of computerized cosmetic selections.

### BRIEF SUMMARY

Embodiments described herein are related to methods, systems, and computer program products that advance the technical field of computerized cosmetic selections/recommendations, by using use hardware sensors and algorithmic analysis on data captured by the hardware sensors to provide personalized, consistent, and objective cosmetic recommendations to a user. As such, the embodiments described herein can increase the objectivity and efficiency of identifying suitable cosmetic products for a particular individual, as compared to existing technical solutions.

In some embodiments, providing a cosmetic recommendation based on skin tone may include capturing, at one or more hardware sensing devices, a scan of a user's face. Providing the cosmetic recommendation may also include determining, from the scan, a skin tone of the user's face. Providing the cosmetic recommendation may also include identifying, based on the skin tone of the user's face, one or more cosmetic products that are recommended for the user. Providing the cosmetic recommendation may also include providing, at one or more hardware output devices, a cosmetic recommendation, the cosmetic recommendation including the one or more cosmetic products that are recommended for the user based on the skin tone of the user's face.

In other embodiments, providing a cosmetic recommendation based on bone structure may include capturing, at one or more hardware sensing devices, a structural scan of a user's face. Providing the cosmetic recommendation may also include determining, from the structural scan, a bone structure of the user's face. Providing the cosmetic recommendation may also include identifying, based on the bone structure of the user's face, one or more cosmetic products that are recommended for the user. Providing the cosmetic recommendation may also include providing, at one or more hardware output devices, a cosmetic recommendation, the cosmetic recommendation including the one or more cosmetic products that are recommended for the user based on the bone structure of the user's face.

In other embodiments, providing a cosmetic recommendation based on a subject cosmetic produce may include capturing, at one or more hardware sensing devices, a scan of a subject cosmetic product. Providing the cosmetic recommendation may also include measuring, from the scan, one or more attributes of the subject cosmetic product. Providing the cosmetic recommendation may also include accessing a cosmetic products database that includes a plurality of cosmetic products, the cosmetic products database including, for each of the plurality of cosmetic products, one or more attributes selected from among a color attribute, a coverage attribute, a viscosity attribute, and a luminosity attribute. Providing the cosmetic recommendation may also include identifying one or more cosmetic products that are recommended for the user based on the color of the subject cosmetic product and based on the one or more measured attributes of the subject cosmetic product. Providing the cosmetic recommendation may also include providing, at one or more hardware output devices, a cosmetic recommendation, the cosmetic recommendation including the one or more cosmetic products that are recommended for the user based on the one or more measured attributes of the subject cosmetic product.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computer architecture for providing cosmetic matching and recommendations, according to one or more embodiments.

FIG. 1B illustrates an example testing device, according to one or more embodiments.

FIG. 2 illustrates a flow chart of an example method for providing a cosmetic recommendation to a user based on skin tone, according to one or more embodiments.

FIG. 3 illustrates a flow chart of an example method for providing a cosmetic recommendation to a user based on bone structure, according to one or more embodiments.

FIG. 4 illustrates a flow chart of an example method for providing a cosmetic recommendation to a user based on a subject cosmetic product, according to one or more embodiments.

FIG. 5 illustrates instruction image, which visually shows a user where and/or how to apply different cosmetic products, according to one or more embodiments.

### DETAILED DESCRIPTION

Embodiments described herein are related to methods, systems, and computer program products that advance the technical field of computerized cosmetic selections/recommendations, by using use hardware sensors and algorithmic analysis on data captured by the hardware sensors to provide personalized, consistent, and objective cosmetic recommendations to a user. As such, the embodiments described herein can increase the objectivity and efficiency of identifying suitable cosmetic products for a particular individual, as compared to existing technical solutions.

For example, embodiments can include a computer system obtaining sensor data of a user's anatomy (e.g., sensor data relating to the user's face), the computer system analyzing the data to form a description of one or more anatomical features of the user (e.g., such as a description of the users' skin tone and/or bone structure), and the computer system providing cosmetic recommendations based on the anatomical features. In some embodiments, the computer system may match the description of the one or more anatomical features to a public figure (such as a celebrity) who has similar anatomical features, and may then provide cosmetic recommendations based on cosmetic products that are known to be used by that public figure. In another example, embodiments can include a computer system obtaining sensor data of a cosmetic product, the computer system analyzing the data to form a description of the cosmetic product (e.g., color, coverage, viscosity, luminosity), and the computer system providing cosmetic recommendations based on the cosmetic product.

In a more specific example, at least some embodiments described herein relate to methods, systems, and computer program products that provide a cosmetic recommendation to a user based on that user's skin tone. Such embodiments can include capturing a photographic image of a user's face and then determining, from the photographic image, a skin tone of the user's face. Such embodiments can also include identifying one or more cosmetic products that are recommended for the user based on the skin tone of the user's face, and providing a cosmetic recommendation to the user. The cosmetic recommendation can include the cosmetic product(s) that were identified as being recommended for the user based on the skin tone of the user's face.

In another example, at least some embodiments described herein relate to methods, systems, and computer program products that provide a cosmetic recommendation to a user based on that user's bone structure. Such embodiments can include capturing a structural scan of a user's face, and then determining, from the structural scan, a bone structure of the user's face. Such embodiments can also include identifying one or more cosmetic products that are recommended for the user based on the bone structure of the user's face, and providing a cosmetic recommendation to the user. The cosmetic recommendation can include the cosmetic product(s) that were identified as being recommended for the user based on the bone structure of the user's face.

In yet one more example, at least some embodiments described herein relate to methods, systems, and computer program products that provide a cosmetic recommendation to a user based on a sample of a cosmetic product (e.g., a remnant). Such embodiments include capturing a photographic image of a subject cosmetic product, and determining, from the photographic image, one or more properties (e.g., color, coverage, viscosity, luminosity) of the subject cosmetic product. Such embodiments may include receiving user input specifying one or more attributes of the subject cosmetic product (e.g., color, coverage, viscosity, luminosity). Such embodiments also include accessing a cosmetic products database that includes a description of plurality of cosmetic products. The cosmetic products database includes, for each of the plurality of cosmetic products, one or more of a color attribute, a coverage attribute, a viscosity attribute, and a luminosity attribute. One or more cosmetic products, which are recommended as being similar to the subject cosmetic product, are identified based on the one or more attributes of the subject cosmetic product. A cosmetic recommendation is provided to the user. The cosmetic recommendation includes the cosmetic product(s) that were identified as being recommended for the user based on the color of the subject cosmetic product and based on the one or more attributes of the subject cosmetic product.

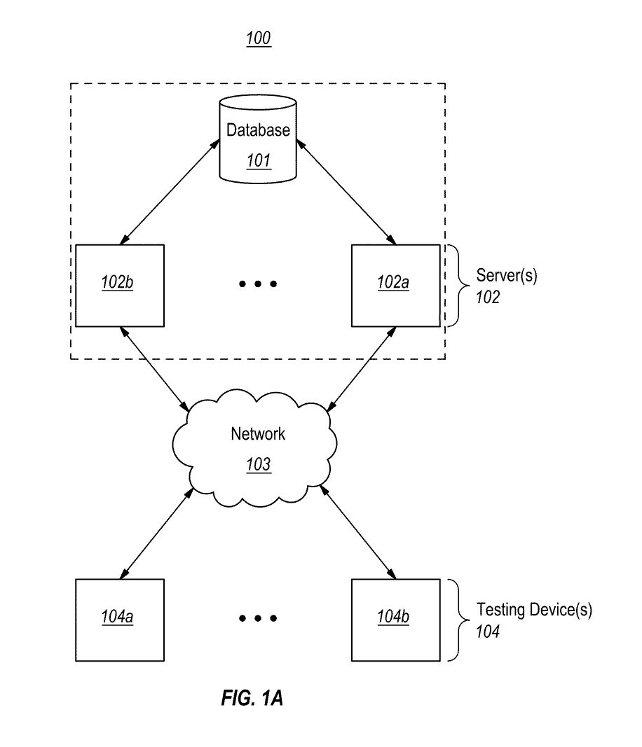

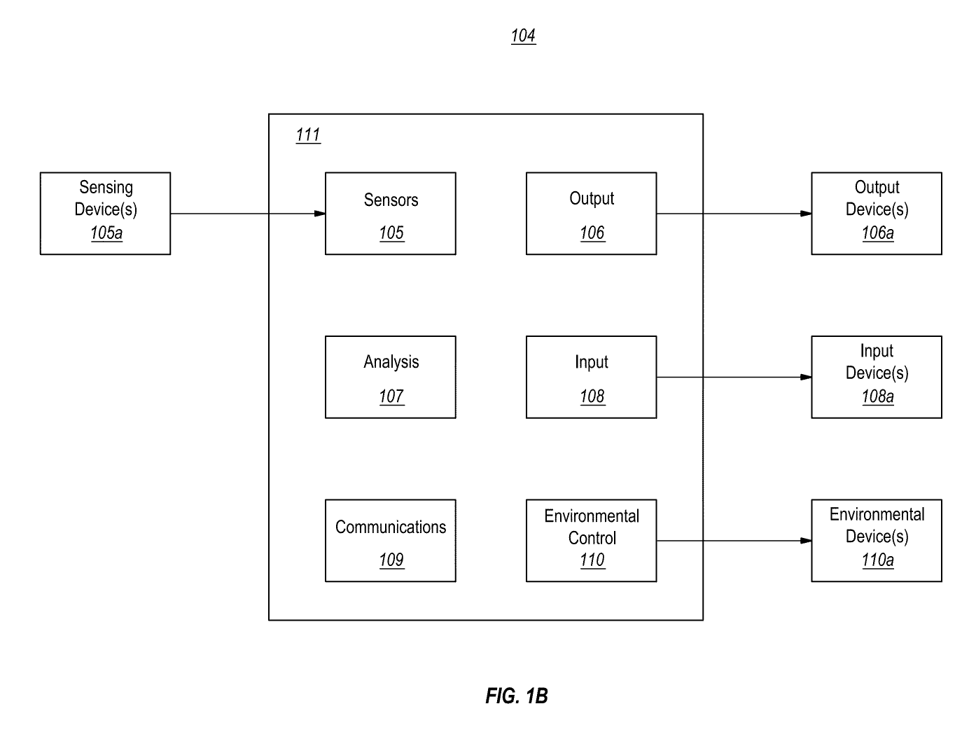

The present invention includes a computer environment in which one or more embodiments described herein may operate. Along these lines, FIG. 1A illustrates an example computer architecture 100 for providing cosmetic matching and recommendations. As depicted, computer architecture 100 includes testing devices 104, which are described in more detail in connection with FIG. 1B. As further depicted, the testing devices may be communicatively coupled to one or more servers 102 over a network 103 (e.g., a Local Area Network (“LAN”), a Wide Area Network (“WAN”), the Internet, etc.). The one or more servers 102 may be further connected to a database 101, which may be a local or a distributed database.

In general, each testing device 104 comprises an apparatus including computer hardware and software, which is configured to provide cosmetic recommendations based on data obtained by one or more hardware sensors of the testing device 104. For example, a testing device 104 may provides a recommendation of cosmetic products to a user of the testing device 104, based on an analysis of the user's skin tone, bone structure, prior-used cosmetic products, desired styles or looks, etc. In some embodiments, testing devices 104 may be a specifically configured as a kiosk or booth, and may be configured to be located in any appropriate location, such as in department stores, at spas, in beauty salons. In some embodiments, testing devices 104 may include a special or general-purpose computer that has been specifically configured for providing cosmetic matching and recommendations, such as by addition of specific hardware and/or be configuration with specifically designed computer-executable instructions. In come embodiments, testing devices 104 may also be configurable to be usable by consumers in their homes.

FIG. 1B illustrates an embodiment of a testing device 104. As depicted, the testing device 104 includes a computer system 111. The computer system 111 may be a special-purpose computer system (e.g., a custom-made embedded system), or may be a general-purpose computer system that has been specially configured for providing cosmetic matching and recommendations. For example, the computer system 111 may be configured to interface with a plurality of hardware devices, including sensors and output devices as described herein, and may be configured with computer-executable instructions that configure the computer system 111 with a plurality of special-purpose modules (e.g., modules 105-110), as described herein.

As depicted, the computer system 111 includes a sensors module 105. In connection with the sensors module 105, the computer system 111 can be communicatively coupled to one or more hardware sensing devices 105a for obtaining sensor data of a user's anatomy and/or obtaining sensor data of a cosmetic sample. For example, although the exact selection and arrangement of the sensing devices may vary, they typically operate to detect a portion of the electromagnetic spectrum (i.e., visible and/or non-visible) and/or detect sound waves. For example, the sensing devices may comprise one or more of a digital camera, a structured light 3D scanner (e.g., a KINECT sensor from MICROSOFT CORPORATION of Redmond, Wash.), an optical scanner, and/or a spectrophotometer (which gathers a quantitative measurement of the reflection or transmission properties of a material as a function of wavelength), a millimeter-wave scanner, a range camera, among other things, which are communicatively coupled to the sensors module 105 of the computer system 111. Any of the foregoing may utilize Charge-Coupled Device (CCD), Complementary metal-oxide-semiconductor (CMOS) circuitry, etc. In addition, any of the sensing devices 105a may be passive (i.e., merely detecting emitted sound waves and/or electromagnetic frequencies), or active (i.e., emitting sound waves and/or electromagnetic frequencies, and detecting their interaction with a subject object).

As depicted, the computer system 111 also includes an output module 106. In connection with the output module 106, the computer system 111 can be communicatively coupled to one or more output devices 106a for providing output to a user. For example, the output devices 106b include one or more of a printer (e.g., to print out a simulation of cosmetics applied to a user, to print out a list of recommended cosmetics, etc.), a monitor (e.g., to display user interfaces and provide interaction with a user), and/or a speaker (e.g., to provide audible feedback/instructions to a user). One of ordinary skill in the art will recognize that other output devices may be usable in connection with the embodiments described herein.

As depicted, the computer system 111 also includes an analysis module 107. The analysis module can implement one or more data processing algorithms on data obtained from the sensing devices 105a, to objectively quantify skin tone, bone/facial structure, attributes of a cosmetic sample, etc. For example, in connection with a spectrophotometer, skin tone may be expressed with Commission International d'Eclairage (CIE) L*a*b* color coordinates and melanin and erythema indexes.

While that particular algorithms used for data processing will vary depending on implementation and desired functionality, example algorithms may include demosaicing, bilinear interpolation, bicubic interpolation, spline interpolation, lanczos resampling, linear interpolation combined with spatiospectral (panchromatic) CFA; algorithms based on the Kubelka-Munk theory of reflectance, etc. It is noted that analysis may be performed at the computer system 111 and/or at the servers 102. As such, any reference to the analysis module 107, or use of algorithms to process data obtained from the sensing devices 105a, refers to processing that can be performed by the analysis module 107 at the computer system 111, at the servers 102, or using a combination of the two.

As depicted, the computer system 111 also includes an input module 108. In connection with the input module 108, the computer system 111 can be communicatively coupled to one or more input devices (e.g., devices 108a-108d) for receiving input from a user. For example, FIG. 1B depicts that the testing device 104 may include a keyboard 108a, a mouse or other pointing device 108b, a microphone 108c, and/or a storage device reader 108d. One of ordinary skill in the art will recognize that other input devices may be usable in connection with the embodiments described herein, such as a touch-sensitive digitizer used in connection with the monitor 106b.

As depicted, the computer system 111 also includes a communications module 109. Thus, the computer system 111 can be communicatively coupled to the network 103, for communications with the servers 102.

As depicted, the computer system 111 may also include an environmental control module 110. As such, the testing device 104 may also comprise one or more environmental devices 110a, such as lighting devices and/or one or more light sensing devices that are configured to provide consistent and/or known lighting conditions during use of the testing device 104. For example, each testing device 104 may comprise a booth (e.g., similar to a photo booth) that blocks a full or partial amount of ambient lighting (e.g., in connection with a curtain or door), and that provides its own lighting in a preconfigured intensity, color temperature, etc. In additional or alternative embodiments, the testing device 104 may measure parameters of existing lighting conditions (e.g., intensity and color temperature) during use of testing device 104, and to process data received at the sensing devices 105a accordingly. In some embodiments, light sensing devices are used as feedback to adjust lighting devices to provide lighting conditions within predetermined thresholds. As such, testing devices 104 can provide for consistent visual testing environments across tests and across individual testing devices, and can gather measurement information that may be usable to adjust any images or scans that are captured.

Each testing device 104 may be configured to operate in a stand-alone configuration, in a network-attached configuration, or even using combinations of the two. For example, as discussed in connection with FIG. 1A, testing devices 104 may be connected by network 103 (e.g., the Internet) to one or more servers 102 that include a database 101. As discussed in more detail later, the servers 102 and database 101 can provide functionality for providing information about cosmetic products, public figures, etc. In some embodiments, testing devices 104 may include local databases (either separate from database 101 or as a cached version of database 101) that allow the testing device 104 to operate without connectivity to the servers 102.

Testing devices 104 can be configured to present one or more user-interactive interfaces, which are configured to guide a user through one or more workflows for aiding in the selection of cosmetic products. For example, a user interface generated by the computer system 111 may include one or more user interface elements for receiving a selection of a mode of operation for recommending cosmetic products based on the user's skin tone. In such a mode of operation, the user interface may be configured to guide the user through capturing a scan of the user's face using the sensing devices 105a (e.g., using a scanner, camera, spectrophotometer, etc.). Then, one or both of the testing device 104 and the servers 102 may determine the user's skin tone using the analysis module 107, and select/recommend cosmetic products based on the user's skin tone. For example, the database 101 may contain records associating skin tones to compatible/recommended cosmetic products. Such recommendations may be further based on identification of public figures having similar skin tones, based on one or more styles or looks requested by the user, etc. Thus, the database 101 may also contain one or more records associating cosmetic products with public figures, styles, etc.

In another example (which may be employed in addition to or as an alternative to the foregoing example of skin tone detection), a user interface generated by the computer system 111 may include one or more user interface elements for receiving a selection of a mode of operation for recommending cosmetic products based on a bone structure of the user's face. In such a mode of operation, the user interface may be configured to guide the user through capturing a scan the user's face using the sensing devices 105a (e.g., using active mechanisms utilizing the emission and detection of sound and/or electromagnetic waves, and/or using passive mechanisms including detecting visible light, infrared light, etc.). Then, one or both of the testing device 104 and the servers 102 may determine the user's bone structure using the analysis module 107, and select/recommend cosmetic products based on the user's bone structure. For example, the database 101 may contain records associating bone structures to compatible/recommended cosmetic products, identifying bone structures of pubic figures, etc. Thus, cosmetic recommendations may be based on the general shape of the user's face (e.g., round, heart, oval, long, square), based on prominent and/or less prominent face features, based on a desire to visually alter one or more facial features, based on identification of public figures having similar bone structure, based on a requested style or look, etc.

In another example (which may be employed in addition to or as an alternative to the foregoing examples of skin tone detection and bone structure detection), a user interface generated by the computer system 111 may include one or more user interface elements for receiving a selection of a mode of operation for that aids a user in selection of cosmetic products based on a remnant of the user's existing cosmetic product. In such a mode of operation, the user interface may be configured to guide the user through capturing an image/scan of a remnant of a cosmetic product using the sensing devices 105a (e.g., using a scanner, camera, spectrophotometer, etc.), such as through capture of the remnant on a provided card/backdrop. Use of a provided card/backdrop can increase the accuracy of a capture, by providing a known and consistent background, by providing background grids/patters (e.g., to help measure coverage), etc. Then, one or both of the testing device 104 and the servers 102 may determine one or more properties of the cosmetic product including, for example, color. Other parameters of the cosmetic product may also be ascertained, either automatically or through user input, such as coverage, viscosity, luminosity, sheen, sparkle, etc. One or both of the testing device 104 and the servers 102 may then recommend one or more other cosmetic products that would be good substitutes. Such determination may include preference considerations such as cosmetic products used by public figures, price, brand, etc.

As discussed previously, the servers 102 and the database 101 can provide processing and/or data store functionality for the testing devices 104. As depicted by the dashed box, the servers 102 and the database 101 may exist together within a local network, such as within a datacenter. In some embodiments, the servers 102 and the database 101 provide a cloud-based back-end service for testing devices 104.

In general, database 101 includes information about cosmetic products, which may include their price, their availability, their attributes (e.g., color, coverage, viscosity, luminosity, sheen, sparkle, etc.), manufacturers, etc. Database 101 may also include information about public figures, such as celebrities. Such public figure information can include data about the public figure's skin tone, bone structure, face shape, and cosmetic products that are used by the public figure. Database 101 may also include demo, review, and/or instructional information, such as references to online videos, articles, pamphlets, etc., that can be disseminated to a user based on a recommend cosmetic product, and/or based on a matched public figure. Database 101 may also include advertising information, which can be disseminated to users through testing devices 104 in any appropriate context or manner.

As noted, database 101 can include information about public figures, such as celebrities, such as cosmetic products and styles that are used by public figures. As such, computer architecture 100 can be used to help a person to identify public figures that have skin and facial features that are similar to their own skin and facial features, and to leverage knowledge of what cosmetic products the public figure uses—and how the public figure uses those products—for cosmetic recommendations. Additionally or alternatively, computer architecture 100 can even be used to help a person not having skin tones and facial features similar to a desired public figure to duplicate that public figure's look on their own skin tones and facial features. As such, computer architecture 100 may adjust color recommendations to duplicate a public figure's look on the user's skin tone and features.

In some embodiments, the testing devices 104 may be configured to simulate application of one or more cosmetic products to the user's face. For example, the testing devices 104 may visually present a generic image of a face, or even a photographic capture of the user's face, and simulate what the generic image or the photograph of the user's face would look like with one or more cosmetic products applied thereto. The testing devices 104 may provide functionality for adjusting the virtual application of each cosmetic product (e.g., order, quantity, location, etc.), for selecting substituting different products, for selecting different combinations of products, etc.

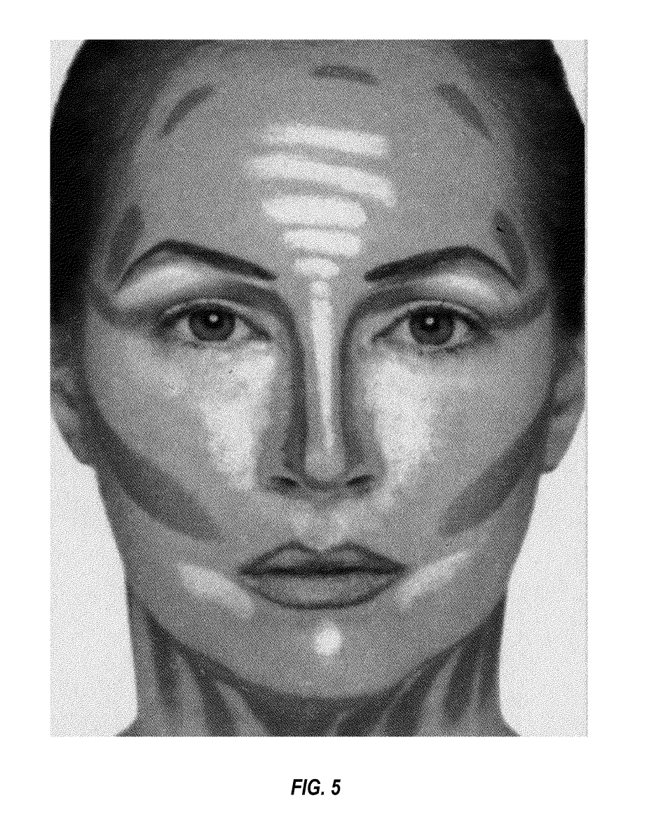

In some embodiments, the testing devices 104 may be configured to instruct a user how to apply cosmetic products. For example, FIG. 5 depicts an example instruction image, which visually shows a user where and/or how to apply different cosmetic products. Such instruction image may guide a user through techniques for emphasizing certain facial features, for deemphasizing certain facial features, for achieving desired color or texture features, etc. Such instruction image may include the user's own face, or may be selected from one or more generic models.

When the testing devices 104 provide cosmetic recommendations, the testing devices 104 can provide rich interactive functionality to the user for filtering and comparing cosmetic products. For example, the user may be enabled to filter products by price, manufacturer, public figure, attribute (e.g., color, coverage, etc.), availability, environmental friendliness, animal friendliness, toxicity, etc. In another example, a user may be enabled two visually compare two or more products side-by-side, such as to compare color, texture, etc. For example, when a user is looking for a substitute of a remnant, the testing device 104 may display the image that was captured of the remnant (or a derivation thereof) side-by-side with images of candidate replacement products.

As indicated previously, database 101 may also include demo, review, and/or instructional information that can be disseminated to a user based on a recommend cosmetic product, and/or based on a matched public figure. Such information may be disseminated to a user by way of electronic mail, SMS/MMS messaging, physical printouts, wireless transfer, communication with a corresponding mobile application, etc.

In addition, the testing devices 104 may be configured to enable a user to purchase recommended cosmetic products at the testing devices 104, such as for home shipment or in-store pickup.

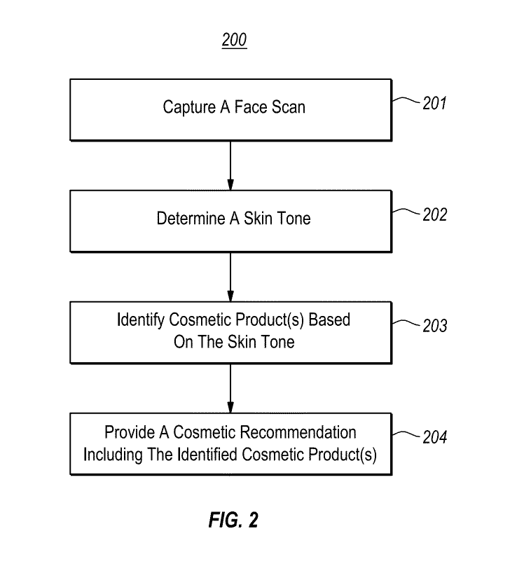

In view of the foregoing, FIG. 2 illustrates a flow chart of an example method 200 for providing a cosmetic recommendation to a user based on skin tone. Method 200 will be described with respect to the components and data of computer architecture 100.

Method 200 comprises an act 201 of capturing a face scan. Act 201 can include capturing a photographic image, spectrophotometer scan, etc. of a user's face using one or more of the sensing devices 105a. In capturing the face scan, the testing device 104 may provide for predefined and controlled lighting conditions (e.g., using the environment control module 110 and environmental devices 110a, and/or may adjust the white balance or other color parameters of a captured photographic image.

Method 200 also comprises an act 202 of determining a skin tone. Act 202 can include determining, from the face scan, a skin tone of the user's face. For example, the testing device 104 may use software algorithms and analysis module 107 to ascertain the skin tone, or the testing device 104 may upload the face scan to the servers 102 for processing.

Method 200 also comprises an act 203 of identifying cosmetic products) based on the skin tone. Act 203 can include identifying, based on the skin tone of the user's face, one or more cosmetic products that are recommended for the user. For example, testing device 104 or server 102 may identify cosmetic products in database 101 that are recommended for the user based on the skin tone. Such recommendation may be made based on identifying one or more cosmetic products having a color that matches the user's skin tone, or having a color that compliments the user's skin tone. The identification of products may be based on price, brand/manufacturer, product line, public figure, etc.

Method 200 also comprises an act 204 of providing a cosmetic recommendation including the identified cosmetic product(s). Act 204 can include providing a cosmetic recommendation to the user, the cosmetic recommendation including the one or more cosmetic products that are recommended for the user based on the skin tone of the user's face. For example, testing device 104 may formulate a cosmetic recommendation, or server 102 may formulate a cosmetic recommendation and send it to testing device 104. Testing device 104 can send then communicate the cosmetic recommendation to the user. Testing device 104 can communicate the cosmetic recommendation using the output module 106 and output devices 106a visually, with a printout, or electronically to one or more of a smartphone, a tablet computer, a desktop computer, or a laptop computer.

Providing a cosmetic recommendation may include visually simulating application of at least one cosmetic product to the scan of the user's face. Providing a cosmetic recommendation may also include providing at least one review of a cosmetic product, which may include sending the user a Uniform Resource Locator (URL) to an Internet video, review, publication, etc.

In some embodiments, the cosmetic recommendation is limited by one or more filter criteria that are received from the user, such as product attributes (e.g., coverage, viscosity, luminosity, etc.), price, brand, celebrity, etc.

In some embodiments, method 200 includes identifying, from a public figure database (e.g., within database 101), at least one public figure having a skin tone that is the same as, or within a predefined color threshold to, the skin tone of the user's face. In such embodiments, the identification of cosmetic products that are recommended for the user comprises identifying, from the public figure database, one or more cosmetic products that are used by the public figure.

In some embodiments, method 200 includes receiving an identity of a public figure (e.g., from the user), and then determining, from a public figure database, a skin tone of the public figure and one or more cosmetic products that are used by the public figure. Based on this information, a color difference between the skin tone of the public figure and the skin tone of the user is determined. Then, the recommended cosmetic products include a color adjustment that allows the user to use products that are similar to the public figure's, but that work with the user's skin tone.

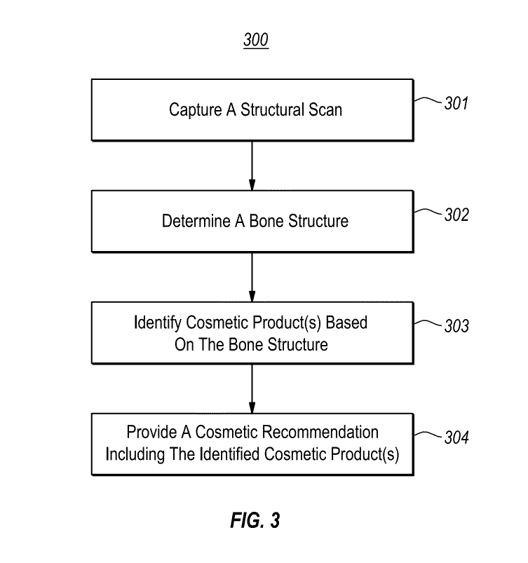

In addition to or as an alternative to the foregoing, FIG. 3 illustrates a flow chart of an additional example method 300 for providing a cosmetic recommendation to a user based on bone structure. Method 300 will be described with respect to the components and data of computer architecture 100.

Method 300 comprises an act 301 of capturing a structural scan. Act 301 can include capturing a structural scan of a user's face. For example, one or more of sensing devices 105a can be used to capture a structural scan of a user face using active and/or passive scanning techniques, as discussed above.

Method 300 also comprises an act 302 of determining a bone structure. Act 302 can include determining, from the structural scan, a bone structure of the user's face. For example, the analysis module 107 can operate one or more algorithms (such as those described above) to determine the user's bone structure. Such analysis may be performed at the testing device 104, or at the servers 102.

Method 300 also comprises an act 303 of identifying cosmetic product(s) based on the bone structure. Act 303 can include identifying, based on the bone structure of the user's face, one or more cosmetic products that are recommended for the user. For example, testing device 104 and/or servers 102 can identify recommended cosmetic products based on the structural scan. Said identification can include identifying one or more cosmetic products that compliment the bone structure (or other features) of the user's face, or that can be used to alter the visual appearance of the bone structure (or other features) of the user's face. Such products can be identified from database 101, and can be selected based on manufacturer, brand, product line, product attributes, etc.

Method 300 also comprises an act 304 of providing a cosmetic recommendation including the identified cosmetic product(s). Act 304 can include providing a cosmetic recommendation to the user, the cosmetic recommendation including the one or more cosmetic products that are recommended for the user based on the bone structure of the user's face. For example, testing device 104 can provide the cosmetic recommendation to the user using the output module 106 and output devices 106a visually, via a printout, electronically (e.g., to one or more of a smartphone, a tablet computer, a desktop computer, or a laptop computer), etc. Providing a recommendation may also include providing a review, demo, etc. via a URL to an Internet resource.

In some embodiments, testing device 104 may presenting a visual map that instructs the user how to apply the recommended cosmetic products to compliment the bone structure (or other feature) of the user's face or alter the visual appearance of the bone structure (or other feature) of the user's face (see, e.g., FIG. 5). Such map may overlay the map over an image of the user's face, or over a generic image of a face.

In some embodiments, cosmetic recommendations are based on the identity of a public figure having a bone structure that is the same as, or within a predefined threshold of, the bone structure of the user's face. In some embodiments, cosmetic recommendations are based on a shape of the user's face, as discussed above.

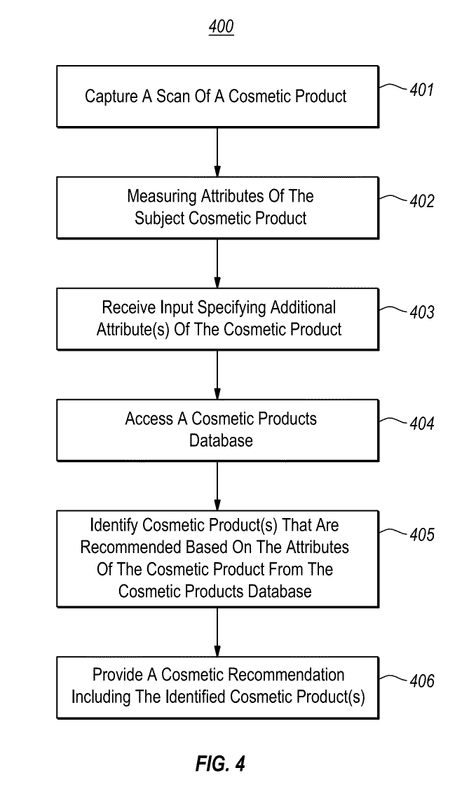

In addition to the foregoing methods, FIG. 4 illustrates a flow chart of an additional example method 400 for providing a cosmetic recommendation to a user based on a subject cosmetic product. Method 400 will be described with respect to the components and data of computer architecture 100, and may be used in addition to or as an alternative to methods 200 and 300.

Method 400 comprises an act 401 of capturing a scan of a cosmetic product. Act 401 can include capturing a photographic image, spectrophotometer scan, etc. of a subject cosmetic product. For example, one or more of sensing devices 106a can capture a scan of a cosmetic remnant, on a controlled background, such as on a standardized card. Act 401 may include adjusting a white balance of the photographic image and/or taking the image under predefined and controlled lighting conditions.

Method 400 also comprises an act 402 of measuring attributes of the subject cosmetic product. Act 402 can include measuring, from the photographic image, one or more of a color attribute, a coverage attribute, a viscosity attribute, and/or a luminosity attribute of the subject cosmetic product. Act 402 may be performed by testing device 104, or by server 102 after receiving the image from the testing device.

Method 400 may also comprise an act 403 of receiving input specifying additional attribute(s) of the cosmetic product. Act 403 can include receiving user input specifying one or more attributes of the subject cosmetic product that could not be obtained in act 402, or which the user would like to modify, such as one or more of a color attribute, a coverage attribute, a viscosity attribute, and/or a luminosity attribute. For example, such input can be received by testing device 104 and communicated to the server 102, if necessary.

Method 400 also comprises an act 404 of accessing a cosmetic products database. Act 404 can include accessing a cosmetic products database that includes a plurality of cosmetic products, the cosmetic products database including, for each of the plurality of cosmetic products, a color attribute, a coverage attribute, a viscosity attribute, and a luminosity attribute of said cosmetic product. For example, the testing device 104 and/or the server 102 can access a cosmetic products database that is part of database 101.

Method 400 also comprises an act 405 of identifying cosmetic products(s) that are recommended based on the color of the cosmetic product from the cosmetic products database. Act 405 can include identifying one or more cosmetic products that are recommended for the user based on the color of the subject cosmetic product and based on the one or more attributes of the subject cosmetic product. For example, testing device 104 and/or the server 102 can identify the recommended cosmetic product(s). Such identification can include filtering by one or more filter criteria that are received from the user, including price, brand, celebrity, skin tone, manufacturer, product line, etc.

Method 400 also comprises an act 406 of providing a cosmetic recommendation including the identified cosmetic product(s). Act 406 can include providing a cosmetic recommendation to the user, the cosmetic recommendation including the one or more cosmetic products that are recommended for the user based on the color of the subject cosmetic product and based on the one or more attributes of the subject cosmetic product. For example, testing device 104 can receive a cosmetic recommendation and communicate it using the output module 116 and output devices 106a to the user visually, via printout, electronically, etc. The testing device 104 can visually simulate application of a cosmetic product to a photographic image of the user's face, may visually compare the color of the subject cosmetic product with the color of the recommended cosmetic product(s), may provide reviews, etc.

As one of skill will appreciate in view of the disclosure herein, each of the foregoing methods may be combined. For example, in a single session, a testing device 104 may capture both a photographic image and a structural scan, and may make cosmetic recommendations based on both skin tone and bone structure. In addition, those recommendations may include cosmetic products that are identified based on a remnant provided by the user.

Accordingly, the embodiments described enable customized cosmetic recommendations for users based on a person's skin tone, based on a person's bone structure, and/or based on a sample of a cosmetic product. Embodiments may also include matching a user with a public figure, such as a celebrity, and providing cosmetic recommendations based on cosmetic products used by the public figure. As such, the embodiments described herein can greatly simplify the process that a person may go through to find suitable cosmetic products, including product replacements.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, implemented at a computer system including one or more processors, one or more hardware sensing device, and one or more hardware output devices, for providing a cosmetic recommendation based on skin tone, the method comprising:
capturing, at the one or more hardware sensing devices, a scan of a user's face;
determining, from the scan, a skin tone of the user's face;
identifying, based on the skin tone of the user's face, one or more cosmetic products that are recommended for the user; and
providing, at the one or more hardware output devices, a cosmetic recommendation, the cosmetic recommendation including the one or more cosmetic products that are recommended for the user based on the skin tone of the user's face.

2. The method as recited in claim 1, wherein capturing the photographic image of a user's face comprises capturing the photographic image under predefined and controlled lighting conditions.

3. The method as recited in claim 1, wherein identifying one or more cosmetic products that are recommended for the user comprises identifying one or more cosmetic products having a color that matches the user's skin tone.

4. The method as recited in claim 1, wherein identifying one or more cosmetic products that are recommended for the user comprises identifying one or more cosmetic products having a color that compliments the user's skin tone.

5. The method as recited in claim 1, wherein providing a cosmetic recommendation to the user comprises visually simulating application of at least one of the one or more cosmetic products to a photographic image of the user's face.

6. The method as recited in claim 1, wherein the one or more cosmetic products that are recommended for the user are limited by one or more filter criteria that are received from the user.

7. The method as recited in claim 1, further comprising:
identifying, from a public figure database, at least one public figure having a skin tone that is the same as, or within a predefined color threshold to, the skin tone of the user's face; and
wherein identifying one or more cosmetic products that are recommended for the user comprises identifying, from the public figure database, one or more cosmetic products that are used by the public figure.

8. A method, implemented at a computer system including one or more processors, one or more hardware sensing device, and one or more hardware output devices, for providing a cosmetic recommendation based on bone structure, the method comprising:
capturing, at the one or more hardware sensing devices, a structural scan of a user's face;
determining, from the structural scan, a bone structure of the user's face;
identifying, based on the bone structure of the user's face, one or more cosmetic products that are recommended for the user; and
providing, at the one or more hardware output devices, a cosmetic recommendation, the cosmetic recommendation including the one or more cosmetic products that are recommended for the user based on the bone structure of the user's face.

9. The method as recited in claim 8, wherein identifying one or more cosmetic products that are recommended for the user comprises identifying one or more cosmetic products that compliment the bone structure of the user's face.

10. The method as recited in claim 8, wherein providing a cosmetic recommendation comprises presenting a map that instructs the user how to apply the one or more cosmetic products to compliment the bone structure of the user's face or alter the visual appearance of the bone structure of the user's face.

11. The method as recited in claim 8, wherein the one or more cosmetic products that are recommended are limited by one or more filter criteria that are received from the user.

12. The method as recited in claim 8, further comprising:
identifying, from a public figure database, at least one public figure having a bone structure that is the same as, or within a predefined threshold of, the bone structure of the user's face; and
wherein identifying one or more cosmetic products that are recommended for the user comprises identifying, from the public figure database, one or more cosmetic products that are used by the public figure.

13. The method as recited in claim 8, further comprising:
determining a shape of the user's face from the structural scan.

14. The method as recited in claim 8, further comprising:
receiving a photographic image of the user's face; and
identifying, from the photographic image, a skin tone of the user's face; and
wherein identifying, based on the bone structure of the user's face, one or more cosmetic products that are recommended for the user comprises identifying one or more cosmetic products that also compliment the skin tone of the user's face.

15. A method, implemented at a computer system including one or more processors, one or more hardware sensing device, and one or more hardware output devices, for providing a cosmetic recommendation based on a subject cosmetic product, the method comprising:
capturing, at the one or more hardware sensing devices, a scan of the subject cosmetic product;
measuring, from the scan, one or more attributes of the subject cosmetic product;
accessing a cosmetic products database that includes a plurality of cosmetic products, the cosmetic products database including, for each of the plurality of cosmetic products, one or more attributes selected from among a color attribute, a coverage attribute, a viscosity attribute, and a luminosity attribute;
identifying one or more cosmetic products that are recommended for the user based on the color of the subject cosmetic product and based on the one or more measured attributes of the subject cosmetic product; and
providing, at the one or more hardware output devices, a cosmetic recommendation, the cosmetic recommendation including the one or more cosmetic products that are recommended for the user based on the one or more measured attributes of the subject cosmetic product.

16. The method as recited in claim 15, wherein capturing a scan of the subject cosmetic product comprises capturing a photographic image of the subject cosmetic product.

17. The method as recited in claim 15, wherein capturing a scan of the subject cosmetic product comprises capturing a spectrophotometer scan of the subject cosmetic product.

18. The method as recited in claim 15, wherein providing a cosmetic recommendation comprises visually simulating application of at least one of the one or more cosmetic products to the photographic image of the user's face.

19. The method as recited in claim 15, wherein providing a cosmetic recommendation comprises visually comparing the color of the subject cosmetic product with the color of the one or more cosmetic products.

20. The method as recited in claim 15, wherein providing a cosmetic recommendation comprises providing one or more of a review of at least one of the one or more cosmetic products, and a Uniform Resource Locator (URL) to an Internet video.
